(19) United States
(12) Patent Application Publication
(10) Pub. No.: US 2012/0083366 A1
(43) Pub. Date: Apr. 5, 2012

(54) LONG LASTING GOLF TEE

(76) Inventor: James Paul O'Sullivan, SR., Leesburg, FL (US)

(21) Appl. No.: 13/286,129

(22) Filed: Oct. 31, 2011

Related U.S. Application Data
(63) Continuation-in-part of application No. 12/540,887, filed on Aug. 13, 2009, now abandoned.
(60) Provisional application No. 61/207,793, filed on Feb. 18, 2009.

(51) Int. Cl. A63B 57/00; B23P 17/04

(52) U.S. Cl. 473/401; 29/592

(57) ABSTRACT

A golf tee for use when striking a golf ball with a golf club. The golf tee includes a long lasting combination of a golf tee and a force absorbing member in association therewith, the tee including a ground insertion end, a ball support end and a shaft in between, the member surrounding the shaft and being located below the ball support end and having an outer diameter less than that of a golf ball but large enough and located so as to protect the support end from impact from a golf club strike after a golf ball has been struck from the tee. A method of making a golf tee is also provided.

### RELATED APPLICATION

This continuation-in-part application claims priority to application Ser. No. 12/540,887 filed Aug. 13, 2009, which in turn claims priority to Provisional Application Ser. No. 61/207,793 filed on Feb. 18, 2009, the contents of which are hereby both incorporated herein by reference in their entirety.

### FIELD

This document relates to the field of golf and in particular to golf tees.

### BACKGROUND

In all of golf the least technically studied aspect thereof is the golf tee. Still it has evolved from a mound of dirt or sand, through wood, to plastic to metal tees. The reason for this lack of technical study is the fact that tees are inexpensive and the motivation for experimentation is largely not there.

As used herein the term long lasting means a tee that can be used in multiple rounds of golf rather than multiple holes of golf. It is intended that this be a limitation in the body of the claims herein.

The benefits of the present invention include, saving many trees and other raw materials and eliminating the time and labor involved in removing broken tees from the golf course.

The tees contemplated herein can be made of any material having a shaft that will withstand the force of striking a ball from the ball support end of the tee when that tee includes the innovation described herein below. Conventional wooden tees cannot withstand this force when using the innovation described herein because the shaft diameter is too small. If wood is to be used herein, the species of wood and the size of the shaft must be such that it can withstand the normal force of a golf swing without breaking. Increasing its diameter to a point where the shaft will not break permits the use of some soft woods. Examples of tees of the appropriate diameter include in addition to some soft woods, the hard woods, bamboo and the like. Among the plastics included are the engineering plastics such as polycarbonate, nylon, polybutylene terephthalate, polyphenylene oxide, etc. Softer plastics such as the polyolefins of the appropriate shaft diameter can also be used. Examples include polyethylene, polypropylene, etc. Among the metals are aluminum, steel, lead, copper, etc. In fact any material previously used as a golf tee can be used herein provided the shaft can withstand the strike force transmitted by the absorbing means described herein.

As will be elaborated on herein below, the problem of damage to the ball support region of the tee, including the tee shaft, has been solved by locating an intercepting member of a natural or man-made material of a particular size and shape at a place on the tee where, after a struck ball has departed the tee, the intercepting member absorbs the force of the club face strike. All this happens in the microsecond after the ball has been struck off the tee. As a result the tee material never gets distorted or rendered unusable. The location and character of the intercepting member is the essence of the invention as has been clear since the filing of Applicant's Provisional Patent Application. This is further bolstered by the non Provisional Application of record herein, see paragraphs [0006], [0018], [0032], [0033] and [0038]. It is to be understood that the exact mechanism of the absorption of the energy of a clubface strike on the material of the shaft enlargement is not important as long as the energy is absorbed so as to protect the ball support region and the shaft itself. Materials that may not be elastic or resilient, but may still function as effective energy absorbers are contemplated. Therefore, any material which can be placed on or be part of the shaft of the tee and be of a dimension and shape as to protect the ball support region and the shaft itself, is contemplated herein.

In the prior art known to applicant, the two most pertinent references are the Copeland U.S. Pat. No. 1,627,012, May 3, 1927 and the Tsukamoto et al Design U.S. Pat. Des 425,155, May 16, 2000. Both references suffer from the same shortcoming, i.e. the shape and location of the rubber band or ring.

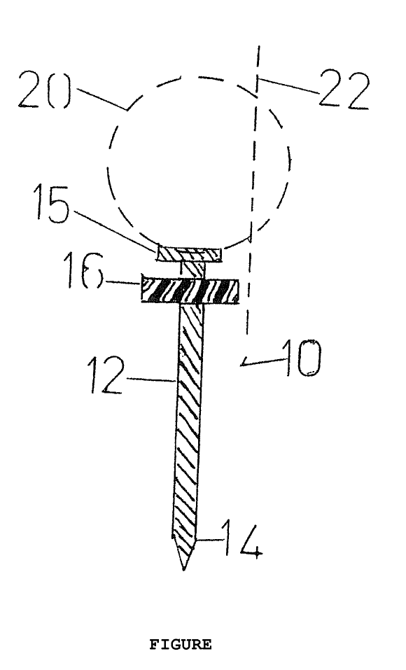

Copeland states regarding FIGS. 3 “ . . . a tapered peg 6 having an enlarged upper end 7 formed with a circumferential groove 8 in which is placed a band 9 of rubber or other suitable resilient material.” page 1, col. 2, lines 76-80. Copeland further states: “In the form shown in FIG. 5 the peg is a straight cone shape having a peripheral groove 11 near the top in which a rubber band 12 is placed.” Page 1, lines 91-94.

Tsukamoto et al. show in their design patent a ring presumably of a resilient material positioned into a groove at the top of a golf tee. Applicant purchased tees identified as being covered by this design patent. The rubber o-ring located in the groove of the tee was so soft that a thumbnail could be pressed against the ring and grounded against the aluminum metal tee. In use the force of normal club strikes began to flatten underlying parts of the ball support region of the tee. This could not by any reasonable interpretation be called a long lasting golf tee.

While no examples of the 1927 golf tees of Copeland are available, it is assumed that if some were available they would also be at least no better than the Tsukamoto et al tees. This is because Copeland gives no details regarding his rubber band. Therefore, it is assumed he is using a soft 1927 vintage rubber band having little or no resistance to a club strike. The tees of Tsukamoto et al also employ soft o-rings that do not protect the underlying aluminum from distortion. The extreme softness, shape and location of the rubber band or ring clearly defeat the intent of the patentees. The force of a golf swing on the band and o-ring of the patentees would and does easily compress the soft rubber and start to deform an aluminum or fiber tee or break a wooden tee. These are not long lasting golf tees.

Vulnerable parts of all golf tees include the concavity and periphery of the ball support regions. Without some effective protection, these regions are easily broken or distorted and are completely useless as parts of long lasting golf tees.

### SUMMARY

In accordance with the present invention, the aforementioned vulnerable parts are protected using a golf tee comprising a long lasting combination of a golf tee having a force-absorbing member in association therewith, the tee including a ground insertion end, a ball support end and a shaft in between, the absorbing member being located below and in protection of the ball support end and having an inner diameter equal to or just smaller than that of the shaft and an outer diameter less than that of a golf ball, the absorbing member being larger in outer diameter than its thickness, the absorbing member being capable of absorbing the force of a golf club strike on a supported ball so as to prevent the force from harming the ball support end. When the absorbing member is resilient it should have a durometer value sufficient to prevent damage to the support end. A durometer value of from about 30 to about 90 prevents such damage.

In one aspect, in its broadest definition, the golf tee herein comprises a long lasting combination of a golf tee and a force absorbing member in association therewith, the tee including a ground insertion end, a ball support end and a shaft in between, the absorbing member being a member surrounding the shaft and being located below the ball support end and having an outer diameter less than that of a golf ball but large enough and located so as to protect the support end from impact from a golf club strike after a golf ball has been struck from the tee. If the absorbing member were an extension of the shaft material it would not tend to move or dislodge during a club strike. If instead, the absorbing member is added to the shaft of the tee, it should form an interference fit therewith, which is an art-recognized type of fit.

In one form, the tee is formed from a material wherein the shaft can withstand damage from a strike on the resilient member.

In another form, the tee is formed from a member selected from the group consisting of wood, plastic and metal.

In another form, the tee is formed from a hardwood.

In another form, the tee is formed from an engineering plastic.

In another form, the tee is formed from a polycarbonate.

In another form, the tee is formed from nylon.

In another form, the tee is formed from a malleable metal.

In another form, the tee is formed from aluminum.

In another form, the absorbing material comprises a natural or man-made material.

In a still further form, the absorbing material has a hardness of from about 30 to about 90 durometer.

In another form, the resilient material comprises a neoprene.

In a still further form, the resilient material is a neoprene having a hardness of from about 50 to about 60 durometer.

In another aspect, provided is a method of making a golf tee for use when striking a golf ball. The method includes the step of forming a long lasting combination of a golf tee and a force absorbing member in association therewith, the tee including a ground insertion end, a ball support end and a shaft in between. The member surrounding the shaft is positioned below the ball support end and has an outer diameter less than that of a golf ball but large enough and located so as to protect the support end from impact from a golf club strike after a golf ball has been struck from the tee.

These and other features will be apparent from the detailed description taken with reference to the accompanying drawing.

### BRIEF DESCRIPTION OF THE DRAWING

Further explanation may be achieved by reference to the description that follows and the drawing illustrating, by way of a non-limiting example, wherein:

The FIGURE is a side view of a tee comprising a long lasting golf tee combination with a force absorbing member thereon herewith shown with a golf ball 20 mounted thereon in phantom lines.

### DETAILED DESCRIPTION

Various aspects will now be described with reference to specific forms selected for purposes of illustration. It will be appreciated that the spirit and scope of the golf tees disclosed herein are not limited to the selected forms. Moreover, it is to be noted that the figure provided herein is not drawn to any particular proportion or scale, and that many variations can be made to the illustrated forms. Reference is now made to the FIGURE.

The meaning of the term “long lasting” depends on the kind of material used to make the tee. In the case of metals such as aluminum, long lasting means many more times over the use of aluminum without the protection of the force-absorbing member. If the aluminum tee without the protector would last on average of say 2 to 4 rounds of golf, then with the protector, tests have shown the tee lasting as much as up to 150 rounds of golf. With plastic tees, it depends on the nature of the plastic. If the shaft of the plastic tee can withstand the force transmitted to it through the force-absorbing member, then the member can do its job and protect the ball support end through many rounds of golf. With wooden tees, having the force-absorbing member tightly located about the shaft, the force of the clubface gets transmitted through the member to the shaft much like a karate chop. An appropriate wood having an appropriate dimension must be chosen to withstand this force before the member can do its job and intercept the clubface thereby protecting the ball support region for many rounds of golf.

Specific examples of metals in addition to aluminum include all malleable metals, such as copper, lead, zinc and the like. Examples of wood include all woods of an appropriate shaft dimension that can withstand the force of a club strike through the force absorbing-member. Examples of plastics include polycarbonate, nylon, polyolefins and the like.

Disclosed herein also is a golf tee comprising, a long lasting combination of a golf tee and a resilient member in association therewith the tee including a ground insertion end, a ball support end and a shaft in between, the resilient member located just below the ball support end and having an inner diameter just less than that of the shaft and an outer diameter less than that of a golf ball, the resilient member being larger in outer diameter than its thickness and having a durometer value sufficient to prevent the force of a golf club strike on a supported golf ball from harming the ball support end.

Referring to the FIGURE, a ball 20 is mounted on tee 10 having a shaft 12 with a teeing ground insertion point 14 at one end and a golf ball support means 15 at the other. Mounted on the shaft below the ball support means is a shaft enlargement member 16. Shown by dotted lines 22 is an approximate compression point where a professional golfer would be expected to compress a ball during a drive off the tee. The width of the shaft enlargement 16 is critical. It must be greater than the outer diameter of the golf ball support means in order to prevent club impact breakage or distortion of the support means. The width of the enlargement also must be less than the diameter of a golf ball. This insures that a struck ball will leave the support before the clubface can strike the shaft enlargement.

In another form, a method of making golf tees for use when striking a golf ball is provided. The method includes the steps of forming a long lasting combination of a golf tee and a force absorbing member in association therewith, the tee including a ground insertion end, a ball support end and a shaft in between. The member surrounding the shaft is positioned below the ball support end and has an outer diameter less than that of a golf ball but large enough and located so as to protect the support end from impact from a golf club strike after a golf ball has been struck from the tee.

The discovery that a force-absorbing material of a particular type and at a specific location on the tee can protect the ball support region of a golf tee and yield a long lasting golf tee combination also led to the discovery that this innovation can be used with a variety of golf tee materials. Originally it was believed that the invention was limited to aluminum type tees. Testing of the innovation disclosed herein with ordinary wooden tees revealed that in far too many cases locating the resilient member on the shaft caused the shaft to break in two. It was as if a karate chop had been delivered to the tee shaft breaking it where the resilient member contacted the shaft or farther up on the shaft due to whiplash. This meant that the use of a resilient member on the shaft of a tee was useless unless the shaft itself could withstand the force transmitted. Therefore, as indicated above, thicker shafts or harder wood of conventional shaft diameters could be used with the innovation disclosed herein. The same is true of tees made of polymeric materials. Simple testing will reveal which materials are candidates to be long lasting tee combinations that then will prevent a clubface from damaging the support region of a tee.

### EXAMPLES

### Example 1

Aluminum gutter spikes were obtained from American Home products, Inc. 450 Richardson Dr. Lancaster, Pa. 17603-4036. These spikes have a 7/32 inch diameter shaft, a 7/16 inch diameter nail head and are about 8 inches long. The shafts have herringbone score lines about most of the circumference thereof. These spikes are normally used to attach rain gutters to homes and other buildings.

One of these spikes was cut to four inches and provided with a concavity in the nail head sufficient to support a golf ball. The opposite end was provided with a taper to accommodate teeing ground insertion. The tee was tested over more than 5 rounds of golf. Examination of the tee revealed only slight bending of the shaft but progressive damage to the periphery of the ball support region. From this it was clear that with the progressive damage to the support region that this could not be termed a long lasting golf tee.

### Example 2

To the tee of Example 1 was applied a Danco faucet stem repair washer just below the ball support end. It has an outside diameter of 25/32 inch, an inner diameter of about 3/16 inch and a center thickness of ¼ inch. The washer was obtained from the Danco Corporation, 2727 Chemsearch Blvd., Irving, Tex. 75062. This member is of neoprene 50-60 shore durometer and it has sufficient resistance to compression so as to prevent the force of the clubface from striking the ball support region of the tee. This tee was used for more than 100 rounds of golf at which time the washer was showing signs of fatigue. The washer was replaced and the tee combination is still in use.

### Example 3

A second identical tee combination was successfully used by Robert Hurley of Monarch Golf Club, Leesburg, Fla. for over 100 rounds of golf. It was also observed that the resilient washer acted somewhat as an air brake if the tee came out of the ground on being hit by the club. This tended to decrease the distance the tee would fly through the air and would accommodate retrieval of the tee.

### Example 4

The density of engineering plastics such as polycarbonate, is about 1.2 g/cm cubed and nylon is 1.15 g/cm cubed. These materials are less than half the density of aluminum. This significant difference in weight versus aluminum are beneficial from a standpoint of cost and the fact that tees of these materials will travel shorter distances if they are hit out of the ground. Tees of these plastics 3½-inch in length having a concave head of ⅞-inch diameter with a 7/32-inch diameter shaft with a pointed insertion end and having a resilient member of exactly the same kind as in Example 2 and located as in Example 2 will provide tees even more beneficial than the aluminum tees of Examples 2 and 3. Having a so-called “neon” dye therein makes retrieval of the tees easier.

### Example 5

Tees made of oak wood of the same dimensions as those of Example 4 and including the same resilient member located as in Example 4 gave the same protection to the ball support region of the tee. Tees of this type, i.e., hard wood tees, will last significantly longer with the use of the resilient member than without it.

The forgoing shows that a tee of any material having a shaft which will withstand the force of a club strike but which would otherwise be vulnerable in the ball support region can avoid this vulnerability by the use of the resilient member.

It is to be understood that the shaft enlargement can be of different shapes, such as one side beveled, both sides beveled, cubic, spherical and so forth, so long as the diameter and thickness relationship is maintained. The length of the tee is important for several reasons. As indicated above, for the present day larger clubfaces of titanium and steel, tees should be longer to accommodate perching the ball where it is most likely to be struck at the sweet spot on the clubface. In addition, since this is a long lasting golf tee, it is important to take all reasonable steps to conveniently locate the tee if it is dislodged from the ground after the ball is struck. Therefore, the longer the tee the better it is, within permissible limits. The preferred length for the longer golf holes is from about 2.7/8 to about no longer than about 4 inches. Particularly preferred is from about 3 to no longer than four inches.

It should be clear from the above description that the tees, except the wooden tees, can be formed with or without the force-absorbing member molded in place. This would be a choice within the skill of the art.

All patents, test procedures, and other documents cited herein, including priority documents, are fully incorporated by reference to the extent such disclosure is not inconsistent with this disclosure and for all jurisdictions in which such incorporation is permitted.

While the illustrative embodiments disclosed herein have been described with particularity, it will be understood that various other modifications will be apparent to and can be readily made by those skilled in the art without departing from the spirit and scope of the disclosure. Accordingly, it is not intended that the scope of the claims appended hereto be limited to the examples and descriptions set forth herein but rather that the claims be construed as encompassing all the features of patentable novelty which reside herein, including all features which would be treated as equivalents thereof by those skilled in the art to which the disclosure pertains.

What is claimed is:

1. A golf tee comprising a long lasting combination of a golf tee and a force absorbing member in association therewith, said tee including a ground insertion end, a ball support end and a shaft in between, said member surrounding said shaft and being located below said ball support end and having an outer diameter less than that of a golf ball but large enough and located so as to protect said support end from impact from a golf club strike after a golf ball has been struck from said tee.

2. The golf tee of claim 1, wherein said tee is formed from a material that enables the shaft to withstand damage from a strike on the resilient member.

3. The golf tee of claim 1, wherein said tee is formed from a member selected from the group consisting of wood, plastic and metal.

4. The golf tee of claim 3, wherein said tee is formed from a hardwood.

5. The golf tee of claim 3, wherein said tee is formed from an engineering plastic.

6. The golf tee of claim 5, wherein said tee is formed from a polycarbonate.

7. The golf tee of claim 3, wherein said tee is formed from nylon.

8. The golf tee of claim 3, wherein said tee is formed from a malleable metal.

9. The golf tee of claim 8, wherein said tee is formed from aluminum.

10. The golf tee of claim 9, wherein said force absorbing member is formed from a force absorbing material comprising a natural or man-made material.

11. The golf tee of claim 1, wherein said force absorbing member is formed from a force absorbing material comprising a natural or man-made material.

12. The golf tee of claim 11, wherein said force absorbing material has a hardness of from about 30 to about 90 durometer.

13. The golf tee of claim 12, wherein said force absorbing material comprises a neoprene having a hardness of from about 50 to about 60 durometer.

14. The golf tee of claim 11, wherein said force absorbing material comprises a neoprene.

15. A method of making a golf tee for use when striking a golf ball, said method comprising the step of forming a long lasting combination of a golf tee and a force absorbing member in association therewith, the tee including a ground insertion end, a ball support end and a shaft in between,
wherein the member surrounding the shaft is located below the ball support end and has an outer diameter less than that of a golf ball but large enough and located so as to protect the support end from impact from a golf club strike after a golf ball has been struck from the tee.

16. The method of claim 15, wherein the tee is formed from a material that enables the shaft to withstand damage from a strike on the resilient member.

17. The method of claim 15, wherein the tee is formed from a member selected from the group consisting of wood, plastic and metal.

18. The method of claim 17, wherein the tee is formed from a hardwood.

19. The method of claim 17, wherein the tee is formed from an engineering plastic.

20. The method of claim 19, wherein the tee is formed from a polycarbonate.

21. The method of claim 17, wherein the tee is formed from nylon.

22. The method of claim 17, wherein the tee is formed from a malleable metal.

23. The method of claim 22, wherein the tee is formed from aluminum.

24. The method of claim 23, wherein the force absorbing member is formed from a force absorbing material comprising a natural or man-made material.

25. The method of claim 15, wherein the force absorbing member is formed from a force absorbing material comprising a natural or man-made material.

26. The method of claim 25, wherein the force absorbing material has a hardness of from about 30 to about 90 durometer.

27. The method of claim 25, wherein the force absorbing material comprises a neoprene having a hardness of from about 50 to about 60 durometer.

28. The method of claim 25, wherein the force absorbing material comprises a neoprene.
